(19) United States
(12) Patent Application Publication
(10) Pub. No.: US 2016/0295672 A1
(43) Pub. Date: Oct. 6, 2016

(54) METHOD AND SYSTEM FOR PROVIDING A DYNAMIC LIGHTING EFFECT TO SPECULAR AND REFRACTIVE OBJECTS

(71) Applicant: PHILIPS LIGHTING HOLDING B.V., Eindhoven (NL)

(72) Inventors: MICHAEL JOHN MURDOCH, PITTSFORD, NY (US); DRAGAN SEKULOVSKI, EINDHOVEN (NL); HELENA BERNADETTE JOS PLASSCHAERT, WAALRE (NL)

(21) Appl. No.: 15/037,413

(22) PCT Filed: Nov. 17, 2014
(86) PCT No.: PCT/IB2014/066087

§ 371 Date: May 18, 2016

Related U.S. Application Data
(60) Provisional application No. 61/905,493, filed on Nov. 18, 2013.

(51) Int. Cl. H05B 37/02; H05B 33/08

(52) U.S. Cl. CPC H05B 37/0281; H05B 37/029; H05B 33/0854; H05B 33/0872; H05B 37/0218; H05B 37/0272

(57) ABSTRACT

A lighting system (10) is provided that enhances the perceived surface lighting effects on specular and refractive objects (14). Light sources (12) are arranged in spatial distribution to one another above, below, or in at least partially surrounding relation to the specular and/or refractive object to be illuminated. A controller (16) is configured, programmed and/or structured to drive each light source with a temporal variation in a lighting parameter (18), such as the intensity, color, or spectral content of each light source, while maintaining a uniform level of illuminance at the object's surface. The geometric arrangement of the light sources coupled with the controller produces a visually perceptible sparkle at the surface of the object.

### TECHNICAL FIELD

The present invention is directed generally to lighting control systems. More particularly, various inventive methods and apparatus disclosed herein relate to dynamically varying light effects of specular and refractive objects while maintaining uniform illumination thereof.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects.

The use of lighting to achieve a desired aesthetic effect of specular and refractive objects is commonly done in the home as well as in retail establishments, museums, offices, and anywhere else where display of such objects is desired. For example, to highlight the quality and cut of a diamond, one may place the diamond in a showcase that has light sources that visually enhance the properties of the diamond. Likewise, crystal glassware may usefully be displayed under light sources that showcase the crystalline structure of the glass. Similarly, shiny, polished metal objects may be preferentially illuminated by light sources that enhance the perception of their texture, facets, and details. Such effects may be realized through placement of one or more light sources around the object to be displayed.

While providing illumination to specular and refractive objects does provide some ability to highlight aesthetic properties and characteristics of the cut and quality of the object, it does little to enhance the characteristic of such objects to produce sparkling effect such as visually perceived when the object is moved in relation to a fixed light source (or conversely, when the object is fixed and the light source providing the illumination is moved). The aspect of light and motion on a specular or refractive object causes the light to be visually perceived as sparkling based upon the change in light parameters as they are refracted through and/or reflected by the surface of the object. These perceived sparkle effects are another desirable quality of specular and refractive objects.

Thus, there is a need in the art to provide a lighting system that provides a perceivable sparkle effect to specular and refractive objects without the use of motion imparted to either the lights or the object.

### SUMMARY

The present disclosure is directed to inventive methods and apparatus for enhancing the perceived surface lighting effects on specular and refractive objects. For example, by providing spatially distributed light sources above, below, and/or in partially surrounding relation to the object to be illuminated, and driving each light source with a temporal variation in a lighting parameter, such as the intensity, color and/or spectral content of each light, the surface effect of the refractive and/or specular object will dynamically vary accordingly. For example, a series of spatially distributed lights positioned in partially surrounding relation to a diamond ring or crystal glass, with each of the lights being driven to change in intensity (or color or spectral content) with time, but while maintaining uniformity of the overall illuminance at the object's surface, a visually perceptible sparkle is produced due to the dynamic nature of the lighting as it is reflected and refracted by the object.

Generally, in one aspect, the invention relates to a lighting system providing a predetermined level of illuminance to at least one specular and/or refractive object. The lighting system includes a plurality of light sources positioned in spatially distributed relation to one another and in spaced relation to the object, and a controller operably connected to the plurality of light sources. The controller is configured and/or programmed to simultaneously vary a predetermined parameter of at least two of the plurality of light sources over a time period and to maintain substantial uniformity in the predetermined level of illuminance during that time period, whereby a visually perceivable lighting effect caused by the specular and/or refractive nature of the object at the surface of the object occurs over the time period. Thus, one aspect of the invention focuses on a lighting system that includes a controller that is configured and/or programmed to temporally control a parameter of at least two light sources such that temporal variations instituted in the light sources produce a visually perceptible surface effect to a specular and/or refractive object. By “visually perceptible” it is meant to infer that an ordinary observer of a specular and/or refractive object that is illuminated by a lighting system is able to see a dynamic variation in the light effects occurring at the surface of the object. More particularly, due to the reflective and/or refractive nature of the object being illuminated and the controlled temporal variations in a light parameter, an ordinary observer would observe what is colloquially referred to as a “sparkling” effect occurring at the object's surface.

In some embodiments, the controller is configured, programmed and/or structured to temporally vary the predetermined parameter of the plurality of light sources according to a predetermined pattern. In some versions of those embodiments, the predetermined pattern may be, for example, a Gaussian pattern where the parameter is maintains a peak or minimum threshold value for some time period between symmetric increases and decrease in value. In some versions of those embodiments, the predetermined pattern could also be, for example, a saw tooth pattern where the parameter value is increased and decreased linearly, or a square-wave pattern where the parameter values are instantaneously increased to a peak or decreased to a minimum threshold value before remaining at that value for some time interval. Other patterns, such as sinusoidal patterns, are certainly also possible variations.

In some embodiments, the controller is configured, programmed and/or structured to temporally trigger the predetermined pattern of variation of the parameter of the plurality of light sources according to a random pattern. In some versions of those embodiments, a random number generator can be connected to or integrated into the controller and be programmed, configured, and/or structured to provide a random input to controller that is representative of a value or pattern that the controller will output to the light sources in order to force the parameter to follow the randomly determined value or pattern.

In some embodiments, the controller is configured, programmed and/or structured to temporally trigger the predetermined pattern of variation of the parameter of the plurality of light sources according to a periodic pattern. In some versions of those embodiments, a clock signal connected to or integrated into the controller and be programmed, configured, and/or structured to provide a periodic trigger to controller that is representative of a value or pattern that the controller will output to the light sources in order to force the parameter to follow the randomly determined value or pattern.

In some embodiments, a user interface is connected to the controller and provides a user of the lighting system with the ability to selectively determine a pattern or to increase or decrease the percentage according to which the parameter will be varied by the controller.

In some embodiments, the plurality of lights can be spatially distributed across one, two or three dimensions. In a one dimensional distribution, the lights can be arranged along a longitudinal axis. In a two dimensional distribution, the lights can be arranged in a flexible mesh or mounted in a spatially distributed grid on a flat surface. In a three dimensional distribution, the lights can be arranged on a curved surface, such as a dome or hemi-sphere. In the three dimensional spatial distribution, it is advantageous to space each of the light sources equidistant from the object to be illuminated.

Generally, in one aspect, a controller for use with a lighting system having a plurality of light sources spatially positioned relative to one another and to a spectral and/or refractive object and adapted to provide a predetermined level of illuminance to the object is configured, programmed and/or structured to vary a predetermined parameter of at least two of the plurality of light sources over a time period such that a visually perceivable lighting effect occurs over the time period at the surface of the object. The controller is further configured, programmed and/or structured to maintain uniformity of the overall level of illuminance at the object.

Generally, in one aspect, a method for controlling at least two light sources arranged to provide illumination to a spectral and/or refractive object is provided, where the light sources are spatially distributed relative to one another and produce a predetermined level of illuminance present at the surface of the object. The method includes the steps of varying a predetermined parameter of at least two light sources over a time period such that a visual perception of the surface of the object varies over the time period, wherein the visual perception is dependent upon the reflective and/or refractive properties of the object, and the step of controlling the variation in the predetermined parameter of each of the at least two light sources such that the predetermined level of illuminance remains constant over the time period.

Generally, in one aspect, a lighting system for use in illuminating and providing a predetermined level of illuminance to at least one specular and/or refractive object includes a first group of light sources adapted for positioning in spatially distributed relation to one another and in spaced relation to the object, and a second group of light sources adapted for positioning in spatially distributed relation to one another and in spaced relation to the first group of light sources and the object, a first controller operably connected to the first group of light sources where the first controller is configured, programmed and/or structured to simultaneously vary a predetermined parameter of at least one light source in the first group over a time period, and a second controller operably connected to the second group of light sources where the second controller is configured, programmed and/or structured to simultaneously vary a predetermined parameter of at least one light source in the second group over the time period. The first and second controllers are each configured, programmed and/or structured to maintain substantial uniformity in the predetermined level of illuminance during the time period. In some embodiments, the first and second controllers are interconnected in a network configuration.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), as well as lasers and other types of electroluminescent sources.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs). Due to the various types of “controllers”, any one of which may be suitable for use in accordance with any aspects of the present invention, controllers will be described as being “configured, programmed and/or structured” to perform a stated function, thus encompassing all possible forms of “controller.”

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers. In addition, the “program” or “computer code” is to be understood as being stored on a non-transitory, computer readable medium.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a lighting system in accordance with an embodiment of the invention;

FIGS. 2a-2c are graphical representations of overall illuminance versus time for two light sources in accordance with embodiments of the invention;

FIG. 3 is a schematic representation of a controller used in accordance with an embodiment of the invention;

FIG. 4 is a schematic representation of a lighting system in accordance with an embodiment of the invention;

FIG. 5 is a schematic representation of a feature of a lighting system in accordance with an embodiment of the invention;

FIG. 6 is a schematic representation of a lighting system in accordance with an embodiment of the invention;

FIG. 7 is a schematic representation of a lighting system in accordance with an embodiment of the invention;

FIG. 8 is a schematic representation of a lighting system in accordance with an embodiment of the invention;

FIG. 9 is a schematic representation of a lighting system in accordance with an embodiment of the invention;

FIG. 10 is a schematic representation of a lighting system in accordance with an embodiment of the invention; and

FIG. 11 is a flow chart of a method for creating a visually perceivable lighting effect caused by the interaction of controlled light sources with the specular and/or refractive nature of an object in accordance with an embodiment of the invention.

### DETAILED DESCRIPTION

In lighting systems designed to produce a certain aesthetic effect on an object, it is desirable to control parameters of the light sources within the lighting system. For example, it may be desirable to have control of which of a plurality of lighting sources are illuminated and/or to have control of one or more lighting parameters of one or more of the lighting sources. For example, it may be desirable to control the dimming rate of light output provided by one or more LED-based light sources. Conversely, it may be desirable to control the rate at which one or more LED-based light sources increases in light intensity. Control of the dimming and/or brightening state of a light source may enable dynamic changes to the perceived effect of an area illuminated by the light source during certain time periods. For example, the perceived effect of diamond ring or crystal glassware that is illuminated in a display may be enhanced by simultaneously and dynamically altering a parameter or parameters of the light sources used to provide the illumination.

More generally, Applicants have recognized and appreciated that it would be beneficial to dynamically vary the lighting effects on a specular and/or refractive object that is on display. While imparting mechanical motion to either the object or the light source will produce a dynamic light effect, it will also undesirably add complexity to the display.

In view of the foregoing, various embodiments and implementations are directed to a dynamic lighting system for use in association with the display of specular and refractive objects. The dynamic lighting system uses a plurality of spatially static light sources each of which produces light and a controller that varies a parameter or parameters of each light source over time while maintaining substantially uniform overall illuminance of the specular and refractive objects on display.

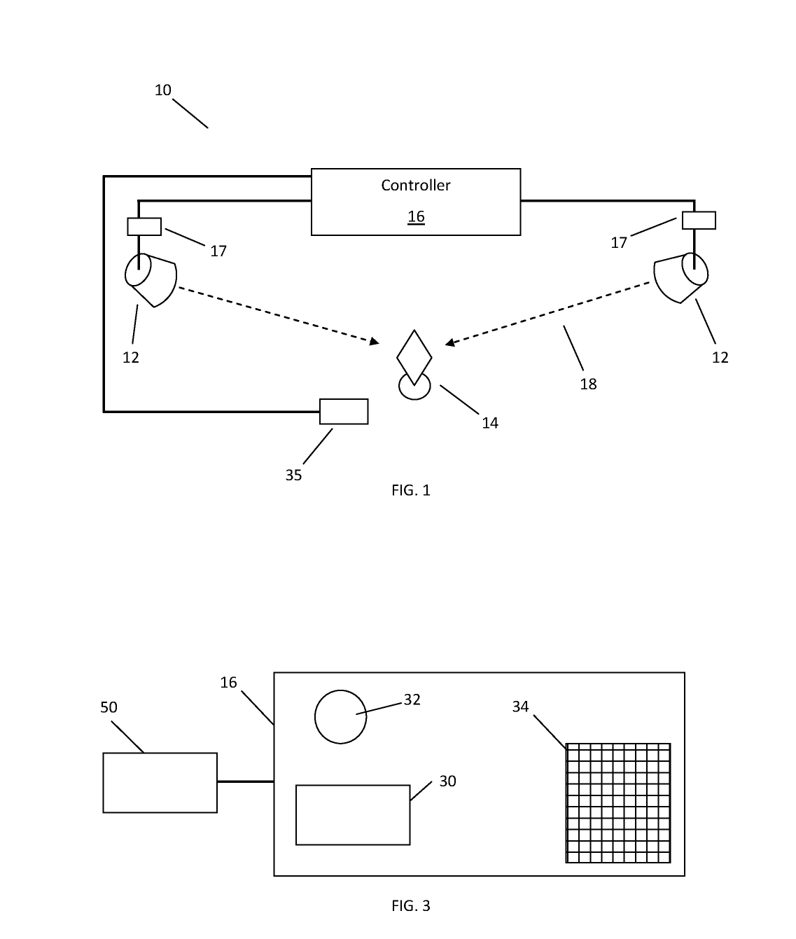

Referring to FIG. 1, in one embodiment, a lighting system, designated generally by reference numeral 10, includes a plurality of light sources 12 positioned in spaced distributed relation to one another and above a specular and/or refractive object 14 for providing a predetermined level of illuminance to the object 14. For example, one or more of the light sources may be an LED-based light source. Further, the LED-based light source may have one or more LEDs, including an array of LEDs in a linear, two-dimensional, or three-dimensional configuration. The light source can be driven to emit light having predetermined attributes (i.e, color intensity, color temperature, etc.). Many different numbers and various types of light sources (all LED-based light sources, LED-based and non-LED-based light sources alone or in combination, etc.) adapted to generate radiation of a variety of different colors may be employed in the lighting system.

Each of the light sources 12 is connected, either physically by wire or cable, or wirelessly, to a controller 16. Controller 16 is configured, programmed, and/or structured to control at least one lighting parameter 18 associated with light sources 12, such as the intensity, color, color temperature, or spectral content of light source 12. Controller 16 causes variation in at least one lighting parameter 18 over time to the light sources 12. This temporal variation in parameter 18 produces a visually perceivable effect to object 14, namely, a scintillating effect (or “sparkle”) caused by the variance in parameter 18 and the reflectivity and/or refractivity of object 14. For example, decreasing the intensity of light from one light source 12 that is directed at a diamond 14 will cause a corresponding decrease in the light being reflected off of and refracted through the surface of the diamond it impinges. Conversely, a corresponding increase in intensity of a different light source 12 at the same time will increase the light being reflected off of and refracted through different surfaces of diamond 14. This simultaneous and dynamic optical effect occurring due to the reflective and refractive nature of diamond 14 will produce a scintillating optical effect commonly or colloquially referred to as a “sparkle.” In addition to controller 16 being configured, programmed and/or structured to vary a parameter 18 of light sources 12 over time, it is also programmed, configured, or structured to control these variations such that the overall illuminance, of object 14 is maintained uniform. Thus, controller 16 both varies parameter 18 of light sources 12 with time (i.e., over time periods), and also maintains uniform illuminance of object 14 over the same time periods.

It should be understood and appreciated that lighting system 10 may include more than two light sources 12, and light sources 12 could be mounted or embedded in a display case, in the ceiling or wall of a room, or in a fixture, lighting unit, or as part of a fabric mesh, among other configurations. In addition, light sources 12 may be incorporated into or attached to one or more luminaires. Furthermore, it is understood and appreciated that each light source 12 will be attached to a source of power. As is also understood and appreciated in the art, each light source may have an integrated or interconnected driver 17 (e.g., a pulse width modulation driver) that receives signals from controller 16 and governs the level of current and/or voltage being delivered to the light source from the power source accordingly.

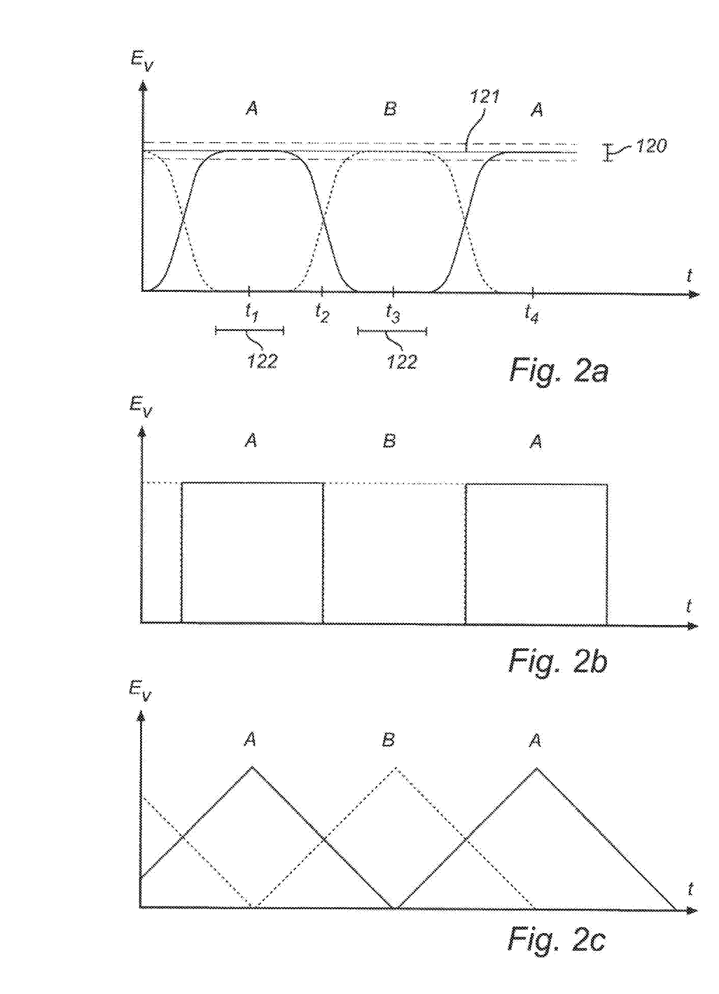

The uniformity of the overall illuminance at object 14 and the temporal variation of parameter 18 over time, t, is graphically illustrated in FIGS. 2a-2c. In FIG. 2a, for example, the changes in the temporal variation patterns for two light sources 12 follow the shape of a Gaussian distribution. In this example, while one light source, represented by the solid line, is increasing its contribution to the illuminance according to a smooth curve and then maintaining a peak illuminance for a certain time period 100 before decreasing following a symmetric pattern to the increasing curve, the other light source 12, represented by the dashed line, does the exact opposite. While FIG. 2a shows that during a time period 200, one light source 12 is at its peak illuminance and the other light source is off (at times t1 and t2, for example), this is not necessary as each light source could remain on, simply at different levels of whatever parameter 18 controller 16 is varying such that the overall illuminance is maintained uniform. In FIG. 2b, the temporal variation pattern follows the shape of a square wave, while in FIG. 2c the variation pattern follows the shape of a saw tooth wave. Of course, other temporal variation pattern shapes, such as sinusoidal, could also be achieved with controller 16.

Controller 16 can be configured, programmed and/or structured to vary parameter 18 of light sources 12. The temporal variation patterns of parameter 18 for light sources 12 may be triggered to start at different points in time by controller 16. In one example of this, the trigger follows a regular clock 32, with the result that the temporal pattern of parameter 18 is periodic.

In another example, the trigger occurs in a randomized fashion, for example triggered by a random number generator 30, which could be integrated with controller 16. Random number generator 30 may, for example, be pre-programmed with any number of patterns that could be implemented by controller 16, and randomly select which of the programs lighting system 10 produces during any given time interval. Alternatively, random number generator 30 may be configured, programmed and/or structured to output random values to the input of controller 16 which then processes the random value and outputs the signal to a light source 12 that corresponds with the random value; the random value may be representative of a percentage increase of decrease of parameter 18, for example. Controller 16 could further be programmed, configured and/or structured to vary the other light source(s) 12 that were not provided the signal representative of the random value such that the overall illuminance remains constant. The time period over which each random value has effect could also be determined by random number generator 30 providing a random value input to a clock 32 that is representative of a time period. In another example, the trigger occurs in a programmed sequence such as provided by a lookup table, a data file, or similar means.

As an example of how controller 16 could be configured, programmed and/or structured to do this, a look-up table 34 could be constructed to contain the data necessary for controller 16 to vary each light source 12 an appropriate amount based on the temporal variation attributed to one light source 12 for purposes of maintaining uniformity of the overall illuminance level at object 14. Look-up table 34 would be stored in memory of controller 16 (or in separate memory that is accessible by controller 16). Thus, as an example, if the parameter 18 of one light source 12 is randomly varied to produce peak illuminance, controller 16 would access the memory in which look-up table 34 is stored and obtain the data representative of the parameter of the other light source(s) 12 (the light sources in system 10 that are not receiving the parameter value determined by random number generator 30) in order to maintain overall illuminance at a uniform level. It should be understood and appreciated that boundaries of parameter values represented by the output of random number generator 30 can be configured, programmed and/or stored in random number generator 30, or could, alternatively, be user selected through use of a user interface 50 in accordance with another embodiment as will be further described hereinafter.

The data representative of the illuminance and/or other parameters 18 of the light sources 12 that is stored in the memory of controller 16 can be predetermined or computed based on measurements made of the lighting system 10. In an example of this, a sensor (35) is placed at or near the position of object 14 which is capable of measuring at least the illuminance of the light reaching its position. The sensor 35 is connected via wired or wireless communications means to the controller 16. One implementation, a set-up calibration, involves a calibration sequence in which the illuminance contribution of each light source 12 is measured individually by the sensor 35 (see FIG. 1). In this calibration sequence, each light source is individually set to a predetermined initial setting and the sensor measures its illuminance. These illuminance values are compared to see if they are substantially uniform. If they are not, the software begins to adjust the settings of the individual light sources 12 to obtain uniformity. Stated differently, the calibration sequence employs a feedback loop wherein the individual light source settings are adjusted until the overall illuminance is substantially uniform. This could be done, for example, when the lighting system 10 is installed or configured or when the objects 14 are arranged or moved, after which the lighting system 10 is ready to use until the configuration changes significantly. Another implementation, a real-time calibration, involves measurement while the lighting system 10 is in use with a control loop. In this implementation, when the illuminance measured by sensor 35 is higher than a threshold above the desired amount, the controller 16 reduces the illuminance contribution of one or more of light sources 12. Likewise, if the measured illuminance is lower than a threshold below the desired amount, the controller 16 increases the illuminance contribution of one or more of light sources 12.

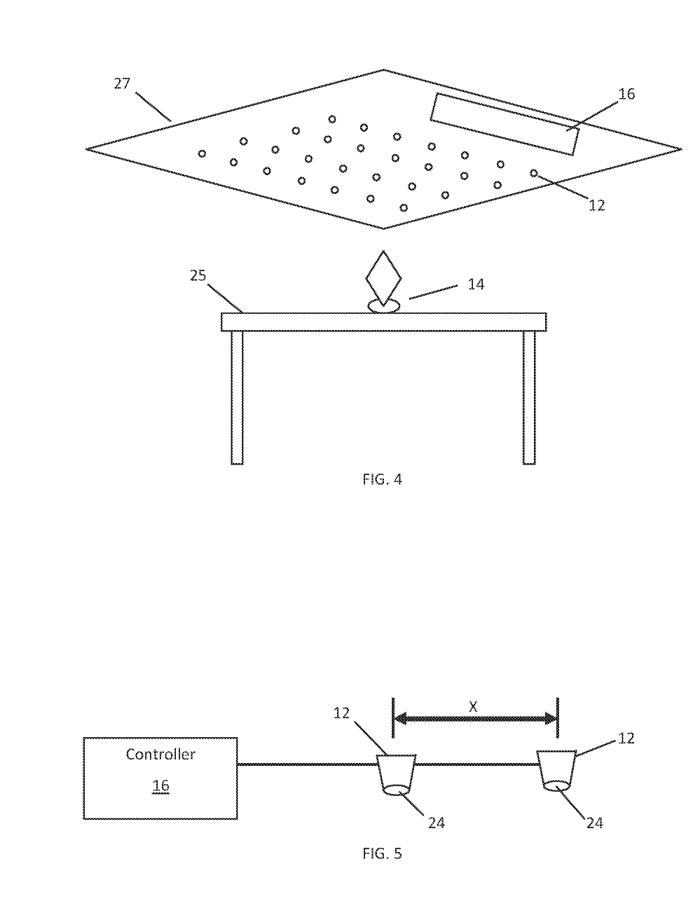

In one embodiment, as seen in FIG. 4, a plurality of light sources 12 are positioned in laterally spaced relation to one another above a specular and/or reflective object 14 (e.g., a crystal glass) sitting on a table 25. The light sources 12 in this illustrated embodiment may be arranged, for example, in a ceiling panel or in a fixture or lighting unit that mounts to the ceiling 27 or as a flexible mesh that attaches the ceiling 27. A parameter 18 (or parameters) of each of the light sources 12 is adapted to be varied over time by controller 16 and a driver 17 associated with each light source 12. The overall illuminance of the plurality of light sources 12, however, remains substantially constant despite the temporal varying of a parameter of each light source 12.

As schematically represented in FIG. 5, each light source 14 includes an exit window/aperture 24 through which light is emitted. An important characteristic of each light source is that the area of the aperture/exit window 24 of the light source must be small relative to the spacing X between adjacent light sources. The ratio of the exit window's area to the spacing X is at most 1:2 and more preferably 1:10. By maintaining a small relative light aperture 24 as compared to the spacing X between light sources 12, each light source 12 will contribute a distinct part of the overall illumination of object 14. Therefore, by maintaining these desired ratios, the scintillating effect produced by lighting system 10 is maximized.

In many embodiments, it is advantageous that the light sources 12 produce a narrow beam angle in order to most effectively produce the dynamic lighting effect achieved with the present lighting system 10. Beam angle describes, for example, the angular width of a light source's intensity profile at half the maximum (central) intensity. A narrow beam angle is for example 30 degrees or preferably 15 degrees.

Each of the light sources may further include a secondary optical structure (not shown) associated therewith for directing or focusing light emitted by it onto the object at a desirable beam angle. Alternatively, the plurality of light sources may operate in conjunction with a common optical system. In yet alternative embodiment, the lighting system is configured to provide a predetermined level of illuminance to the object 14 without an additional optical structure.

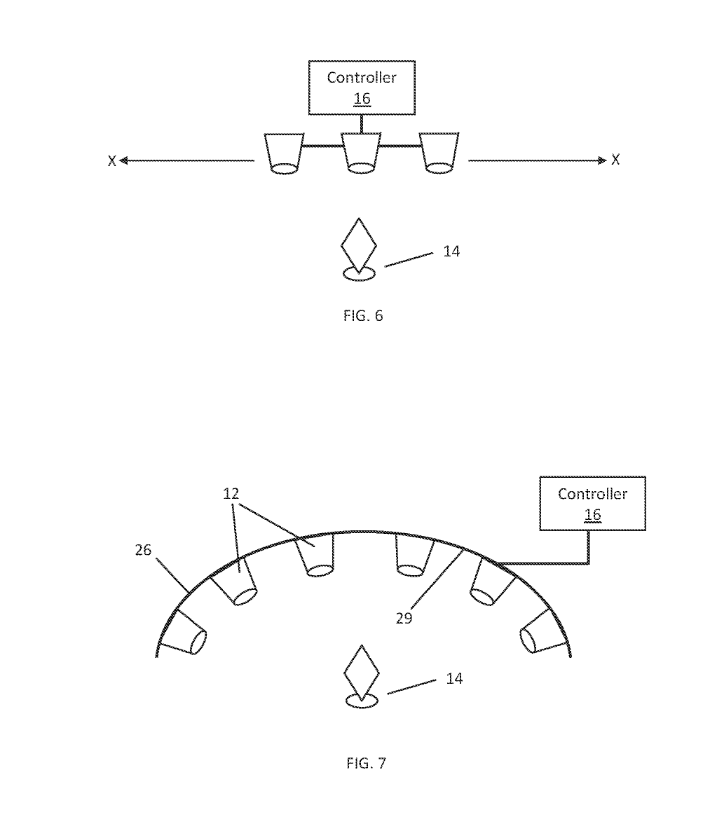

In addition to the two-dimensional geometry provided in FIG. 4, another aspect of the invention, as shown in FIG. 6, is to include a plurality of light sources 12 that extends in one dimension, such as along a longitudinal axis X-X. A track, rail or other conventional light mounting member can be used to facilitate this geometry. The operation of this embodiment is the same as the operation of the embodiment of FIG. 1, although controller 16 will be configured, programmed and/or structured differently to account for the difference in the illuminating effect produced by this geometry of light sources 12.

Another example of geometry of light sources 12 is provided in FIG. 7, wherein light sources 12 are spaced across three dimensions. In this embodiment, each light source 12 is mounted to the concave surface 29 of a curved structure 26, such as a cylinder, hemi-cylinder, barrel-vault, dome, hemi-sphere or sphere. Object 14 is positioned within the footprint of the curved structure 26 and is equidistant from each of the light sources 12. By maintaining equidistance of the object 14 from light sources 12, any effects of diffusion or scattering of light will be minimized, and the scintillating effect produced by the lighting system 10 will be enhanced. As with the embodiment illustrated in FIG. 1, controller 16 is configured to simultaneously vary at least one parameter of at least two light sources 14 over a time period while maintaining a uniform level of illuminance at the surface of object 14 over this same time period.

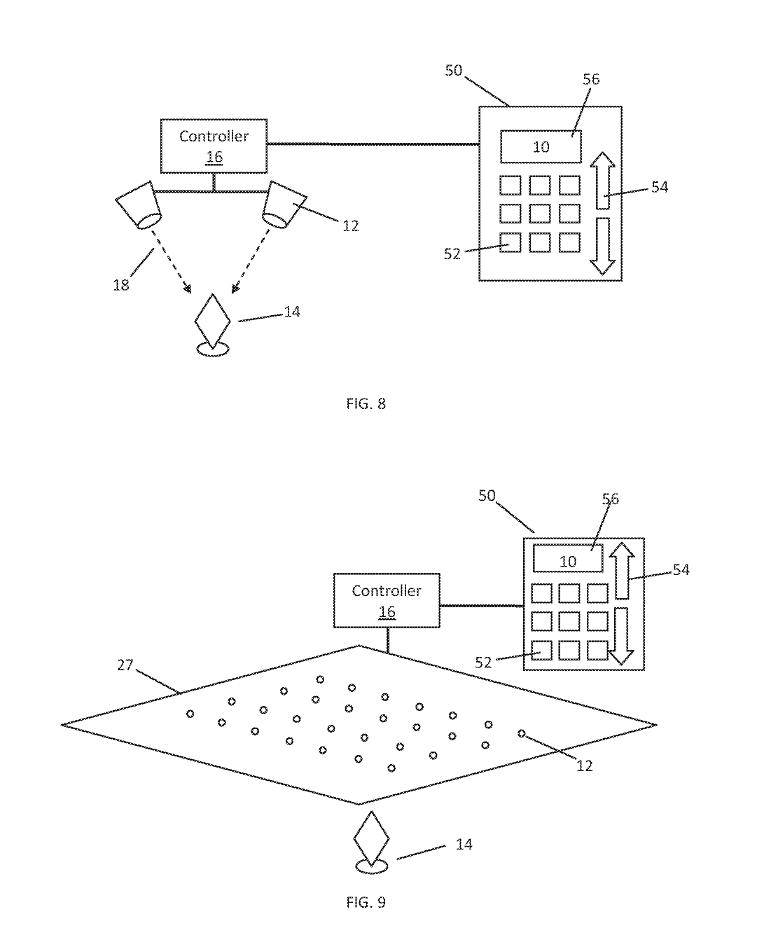

In reference to FIG. 8, another feature that can be employed in any of the disclosed embodiments is a user interface 50. Controller 16 can be integrated with user interface 50 so as to permit a user to selectively control the level of changes that can be made to the parameter 18 or to pick a preprogrammed temporal pattern of illumination. Thus, as an example, a user can selectively increase or decrease the degree to which each light source's 12 parameter will be varied, thereby increasing or decreasing, respectively, the amount of dynamic variation in the lighting effect. The amount of dynamic variation can be modulated via controller 16 by changes in the speed, amplitude, and/or randomness, for example, of the temporal variations in parameter 18. For example, a user can select, using a keypad 52 or up and down arrows 54, on user interface 50 a percentage between 0 (no perceivable dynamic effect) and 100 (strong dynamic effect) that is displayed on a screen 56 based on his/her desired lighting effect. Any number between 0 and 100 will produce a portion of the dynamic effect the system 10 is capable of producing. Other numerical ranges or a simple graphical slider are alternative interface elements.

As an additional example, user interface 50 can be programmed, configured and/or structured to provide a user with the ability to select a desired percentage of the overall maximum illuminance system 10 is capable of providing based upon the wattage or other light parameters of light sources 12. For example, a user can select, using a keypad 52 or up and down arrows 54, on user interface 50 a percentage between 0 (system 10 is “off”) and 100 (system 10 provides its maximum illuminance) that is displayed on a screen 56 based on his/her desired lighting effect. Any number between 0 and 100 will produce a portion of the maximum illuminance system 10 is capable of producing. Other numerical ranges or a simple graphical slider are alternative interface elements.

In reference to FIG. 9, another aspect is to provide coordination of the lighting changes in a spatially organized way. To achieve this, controller 16 is configured, programmed and/or structured to vary the parameter 18 of light sources 12 in a spatially organized manner. For example, controller 16 may increase the parameter 18 of groups of light sources 12, designated A, while correspondingly decreasing those light sources 12 in groups B and C. During the next time period, the parameter 18 for light sources in group A will increase while those in groups B and C will decrease. For the next time period, light sources 12 in group B will increase while those in groups A and C will decrease. The amount and rate at which the parameters 18 of light sources 12 in groups A, B, and C, in this example, can be varied to provide the desired effect, such as creating the visual perception of light moving across the lighting system 10.

An alternate feature of this same embodiment of the invention shown in FIG. 9, in addition to controller 16 controlling the spatially coordinated temporal variations of light sources 12, controller 16 can also be configured, programmed and/or structured to vary the color (assuming the other parameter of light sources 12 being controlled by controller 16 is something other than color, such as intensity, for example) of light sources 12 throughout the day. In this embodiment, as an example, lighting system 10 can produce a lighting effect that mimics the changes in geometry and color of sunlight over the course of a day. In addition, the lighting effect may be controlled by controller 16 faster than real-time, such as over the course of seconds or minutes as opposed to hours in order for an observer of system 10 to experience such lighting effects in a reasonable period of time.

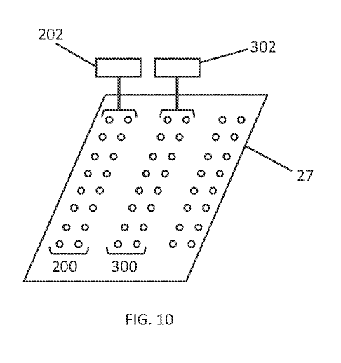

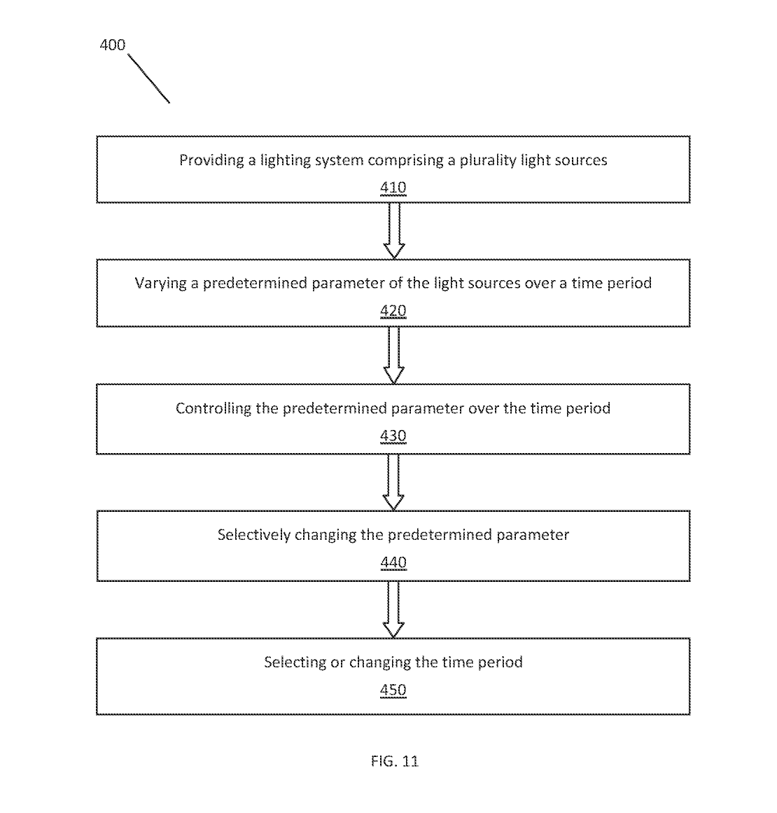

Another aspect as shown in FIG. 10, provides for two (or more) groups of light sources 200 and 300 each of which is controlled by a controller 202 and 302, respectively, as well as each having separate power supplies. Controllers 202, 302, can be programmed, configured and/or structured to produce lighting effects in any of the manners described herein. In addition, controllers 202 and 302 can be connected within a network. In a networked configuration, each controller 202, 302 can be configured, programmed and/or structured such that one controller, 202 for example, can respond in a predetermined manner to whatever lighting effect is being produced by the other controllers, 302 in this example.

It should be understood and appreciated that each light source 12, regardless of the geometry of system 10, the predetermined parameter of light that is temporally varied could be any of the light's intensity, color, color temperature, spectral content, or any combination of these. In addition, regardless of the geometry of the system 10, controller 16, as stated above, is configured, programmed, and/or structured to control at least one lighting parameter associated with light sources 12, such as the intensity, color, color temperature, and/or spectral content of light source 12. In addition, controller 16 is configured, programmed, and/or structured to maintain the temporal uniformity of the overall illuminance at object 14 despite the temporal variations in parameter affected by light sources 14. Such a system has advantageous applications in retail displays to highlight the scintillating properties of a specular and/or refractive object such as a diamond ring, crystal glassware or metal objects, in museums where works of art composed of refractive and/or specular material are displayed, in hotels and restaurants to provide scintillating lighting effects to jewelry and dinnerware, among many others.

Referring to FIG. 11, in accordance with an embodiment is a flow chart illustrating a method 400 for controlling a light source 12 to provide illumination to a spectral and/or refractive object 10 and create a visually perceivable lighting effect caused by the interaction of the light with the specular and/or refractive nature of the object is disclosed. In step 410 is provided a lighting system with at least two light sources 12 each positioned in spaced relation to one another and to a spectral and/or refractive object in order to provide illumination to the spectral and/or refractive object 10 with a predetermined level of illuminance. The light source 12 can be any of the embodiments described herein or otherwise envisioned. For example, light source 12 can be an LED-based light source. Further, the LED-based light source may have one or more LEDs, including an array of LEDs in a linear, two-dimensional, or three-dimensional configuration. The light source can be driven to emit light of a predetermined character (i.e, color intensity, color temperature, etc.). Many different numbers and various types of light sources (all LED-based light sources, LED-based and non-LED-based light sources alone or in combination, etc.) adapted to generate radiation of a variety of different colors may be employed in the lighting system.

The lighting system 10 may also include a controller configured to control one or more lighting parameters 18 associated with light sources 12, such as the intensity, color, color temperature, or spectral content of light source 12. According to an embodiment, controller 16 causes variation in at least one lighting parameter 18 over time to the light sources 12, and this temporal variation in parameter 18 produces a visually perceivable effect to object 14, namely, a scintillating effect (or “sparkle”) caused by the variance in parameter 18 and the reflectivity and/or refractivity of object 14. In additional the lighting system 10 may also include an integrated or interconnected driver 17 (e.g., a pulse width modulation driver) that receives signals from controller 16 and governs the level of current and/or voltage being delivered to the light source from the power source accordingly.

In step 420, one or more predetermined parameters 18 of the two or more light sources 12 are varied over a time period such that a visual perception of the surface of the object in the emitted light varies over the time period. The visual perception is dependent upon the interaction of the light with the reflective and/or refractive properties of the object. In step 430, the variation in the one or more predetermined parameters 18 of each of the two or more light sources 12 are controlled, such as by controller 16, such that the predetermined level of illuminance remains constant over the time period.

In optional step 440, the predetermined parameter is intentionally altered, changed, or modified. For example, a user or program or sensor can selectively alter, change, or modify the predetermined parameter by a certain percentage or range. For example, controller 16 can be configured or programmed so as to permit the selective control of the level of changes that can be made to the parameter 18 or to pick a preprogrammed temporal pattern of illumination. Thus, as an example, a user can selectively increase or decrease the degree to which each light source's 12 predetermined parameter will be varied, thereby increasing or decreasing, respectively, the amount of dynamic variation in the lighting effect. The amount of dynamic variation can be modulated via controller 16 by changes in the speed, amplitude, and/or randomness, for example, of the temporal variations in parameter 18. For example, a user can select, using a keypad 52 or up and down arrows 54, on user interface 50 a percentage between 0 (no perceivable dynamic effect) and 100 (strong dynamic effect) that is displayed on a screen 56 based on his/her desired lighting effect. Any number between 0 and 100 will produce a portion of the dynamic effect the system 10 is capable of producing. Other numerical ranges or a simple graphical slider are alternative interface elements.

In optional step 450, the duration of the time period is selected and/or modified. For example, controller 16 can be configured, programmed and/or structured with temporal variation patterns of parameter 18 for light sources 12 which may be triggered to start at different points in time by controller 16. In one example of this, the trigger follows a regular clock 32, with the result that the temporal pattern of parameter 18 is periodic. In another example, the trigger occurs in a randomized fashion, for example triggered by a random number generator 30, which could be integrated with controller 16.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Reference numerals appearing between parentheses in the claims, if any, are provided merely for convenience, and should not be construed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A lighting system for providing a predetermined level of illuminance to at least one object, the system comprising
a plurality of light sources in spaced relation to the object, said system is characterized by further comprising:
a controller operably connected to said plurality of light sources, wherein said controller is configured, programmed and/or structured to simultaneously vary a predetermined parameter of at least two of said plurality of light sources over a time period and to maintain substantial uniformity in the predetermined level of illuminance during said time period, wherein the object is specular and/or refractive and whereby a visually perceivable lighting effect caused by the interaction of light with the specular and/or refractive nature of the object at a surface of the object occurs over said time period, wherein the plurality of light sources are adapted for positioning in spatially distributed relation to one another and wherein each of the light sources are configured such that a ratio of an exit window of the light source to a distance to a nearest light source of the plurality of light sources is at most 1/2.

2. The lighting system according to claim 1, wherein said controller is configured, programmed and/or structured to temporally vary said predetermined parameter of said plurality of light sources according to a predetermined temporal pattern that is triggered over time.

3. The lighting system according to claim 2, wherein said predetermined pattern is a Gaussian pattern, a saw tooth pattern or a square-wave pattern.

4. (canceled)

5. (canceled)

6. The lighting system according to claim 2, wherein the predetermined temporal pattern is triggered according to a temporally periodic pattern, or a temporally randomized pattern.

7. (canceled)

8. (canceled)

9. The lighting system according to claim 1, further comprising a user interface connected to said controller.

10. The lighting system according to claim 9, wherein said user interface is configured, programmed and/or structured to permit selective user input of a percentage level that is output to said controller, whereby said controller will vary said predetermined level of illuminance according to said percentage level.

11. The lighting system according to claim 9, wherein said user interface is configured, programmed and/or structured to permit selective user input of a percentage level that is output to said controller, whereby said controller will vary the amount of temporal variation of a predetermined parameter according to said percentage level.

12. The lighting system according to claim 9, wherein said user interface is configured, programmed and/or structured to permit selective user input of a predetermined temporal pattern that is output to said controller, whereby said controller will vary said predetermined parameter according to said percentage pattern.

13. The lighting system according to claim 1, wherein said predetermined parameter of said light sources is any of said light sources' intensity, color, and/or spectral content, or any combination thereof.

14. The lighting system according to claim 1, wherein each of said plurality of light sources is spatially separated from one another along a longitudinal axis, or is interconnected to one another in a flexible mesh.

15. (canceled)

16. (canceled)

17. (canceled)

18. (canceled)

19. (canceled)

20. (canceled)

21. The lighting system according to claim 1, wherein the predetermined parameter includes a spectral content of the light emitted by the at least two of said plurality of light sources.

22. The lighting system of claim 2, wherein the temporal variation of the predetermined parameter is in substantial conformance with a season, with a daily cycle, or with an hourly cycle.

23. (canceled)

24. (canceled)

25. The lighting system of claim 2, wherein the predetermined parameter is varied at least once per unit measure of time, the unit measure of time being substantially within a range between one-half second and a minute.

26. A method for controlling at least two light sources each positioned in spaced relation to one another and to an object, wherein said method is characterized by comprising the steps of:
varying a predetermined parameter of said at least two light sources over a time period such that a visual perception of a surface of the object varies over said time period, wherein the object is spectral and/or refractive, wherein the visual perception is dependent upon the interaction of light with the reflective and/or refractive properties of the object and wherein the at least two light sources provide a predetermined level of illuminance present at the surface of the object; and
controlling the variation in the predetermined parameter of each of said at least two light sources such that the predetermined level of illuminance remains constant over said time period, wherein each of the at least two light sources are configured such that a ratio of an exit window of the light source to a distance to a nearest light source of the at least two light sources is at most 1/2.

27. The method according to claim 26, comprising the further step of selectively altering the percentage change of said predetermined parameter.

28. The method according to claim 26, comprising the further step of selecting the duration of said time period.

29. The lighting system according to claim 1, wherein plurality of light sources comprises a lighting system for providing a predetermined level of illuminance to at least one specular and/or refractive object, comprising:
a first group of light sources adapted for positioning in spatially distributed relation to one another and in spaced relation to the object and
a second group of light sources adapted for positioning in spatially distributed relation to one another and in spaced relation to said first group of light sources and the object
the controller includes a first controller operably connected to said first group of light sources, wherein said first controller element is configured, programmed and/or structured to simultaneously vary the predetermined parameter of at least one light source in said first group over said time period, and includes
a second controller element operably connected to said second group of light sources, wherein said second controller element is configured, programmed and/or structured to simultaneously vary the predetermined parameter of at least one light source in said second group over said time period; and
wherein, said first controller element and said second controller element are each configured, programmed and/or structured to maintain substantial uniformity in the predetermined level of illuminance during said time period.

30. The lighting system according to claim 2, wherein said first and second controller elements are interconnected in a network configuration.

31. The lighting system according to claim 1, wherein said ratio is at most 1/10.

32. The method according to claim 26, wherein said ratio is at most 1/10.
